(19) United States
(12) Patent Application Publication
(10) Pub. No.: US 2025/0021888 A1
(43) Pub. Date: Jan. 16, 2025

(54) MODEL TRAINING METHOD AND APPARATUS

(71) Applicant: MaShang Consumer Finance Co., Ltd., Chongqing (CN)

(72) Inventor: Hongyu ZHAO, Chongqing (CN)

(21) Appl. No.: 18/897,862

(22) Filed: Sep. 26, 2024

(30) Foreign Application Priority Data
Mar. 18, 2024 (CN) 202410308776.3

(51) Int. Cl. G06N 20/00; G06F 40/279

(52) U.S. Cl. CPC G06N 20/00; G06F 40/279

(57) ABSTRACT

The present application relates to a model training method and an apparatus. The model training method includes: processing a text in a corpus to obtain a plurality of samples, where the plurality of samples includes a plurality of positive samples and a plurality of negative samples; building a plurality batches of training sets; inputting each batch of training set into a model for training, and obtaining a category of each sample in each batch of training set; and obtaining an overall loss value according to label information and the category corresponding to each sample, a sample quantity and an overall loss function in each batch of training set, and adjusting the model according to the overall loss value to obtain a trained model.

### CROSS-REFERENCE TO RELATED APPLICATIONS

This application claims priority to Chinese Patent Application No. 202410308776.3, filed on Mar. 18, 2024, which is hereby incorporated by reference in its entirety.

### TECHNICAL FIELD

The present application relates to the technical field of intention identification and, in particular, to a model training method and an apparatus.

### BACKGROUND

In a scenario of intention identification, intention of a text is closely related to an expression of the text. However, an intention identification model in the related technology can only identify an intention category of the text with completely different text expressions, which leads to poor accuracy of intention identification for the text.

### SUMMARY

The purpose of the embodiments of the present application is to provide a model training method and an apparatus, which are used to improve the accuracy of intention identification for the text.

In a first aspect of an embodiment of the present application, there is provided a model training method, which includes:
processing a text in a corpus to obtain a plurality of samples, where the plurality of samples include a plurality of positive samples and a plurality of negative samples;
building a plurality batches of training sets, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs;
inputting each batch of training set into a model for training, and obtaining a category of each sample in each batch of training set; and
obtaining an overall loss value according to the label information and the category of each sample in each batch of training set, a sample quantity in each batch of training set and an overall loss function, and adjusting the model according to the overall loss value to obtain a trained model.

In a possible implementation, the obtaining the overall loss value according to the label information and the category of each sample in each batch of training set, the sample quantity in each batch of training set and the overall loss function includes:
determining the overall loss function, where the overall loss function includes a first loss function and a second loss function;
obtaining a first loss value according to the label information and the category of each sample in each batch of training set and the first loss function;
determining a second loss value according to the quantity of the positive samples, a quantity of positive samples with the negative samples, the quantity of the negative samples in each batch of training set and the second loss function; and
obtaining the overall loss value according to the first loss value, a weight of the first loss value, the second loss value and a weight of the second loss value.

In a possible implementation, the first loss function is determined based on the following formula:

$${L}^{CE} = - \frac{1}{N} {\sum }_{i = 1}^{N} {\sum }_{k = 1}^{K + 1} {y}_{i , k} \cdot log {\hat{y}}_{i , k}$$

where y indicates the label information, N indicates the sample quantity in each batch of training set, K indicates a category quantity, ŷ indicates the category, and i indicates an index of the positive samples.

In a possible implementation, where the second loss function is determined based on the following formula:

$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 )$$

where M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max(pᵢ^{m}−pⱼⁿ+δ, 0) is used to measure a distance between the predicted probability of the category of the positive sample and the predicted probability of the category of a corresponding negative sample.

In a possible implementation, the adjusting the model according to the overall loss value to obtain the trained model includes:
if the overall loss value is within a preset range, determining that the adjusted model has converged, and taking the adjusted model as the trained model.

In a possible implementation, the method further includes:
when the overall loss value is not within the preset range, generating a new positive sample by using a principle of maximizing a loss value obtained based on a loss function;
calculating a cluster center of each negative sample, and generating a new negative sample based on the cluster center;
obtaining a new batch of training set based on the new positive sample and the new negative sample, and inputting the new batch of training set into the adjusted model for training to obtain a new category of each sample in the new batch of training set; and
obtaining a new overall loss value according to label information and the new category of each sample in the new batch of training set and the overall loss function, and determining whether the new overall loss value is within the preset range.

In a possible implementation, the processing the text in the corpus to obtain the plurality of negative samples includes:
identifying the positive samples in the corpus;
performing an word extraction processing on each positive sample to obtain a candidate word corresponding to each positive sample; and respectively building a corresponding regular expression based on the candidate word corresponding to each positive sample; and
building the negative sample corresponding to the positive sample based on each regular expression.

In a second aspect of an embodiment of the present application, there is provided a model training apparatus, which includes:
an obtaining unit, configured to process a text in a corpus to obtain a plurality of samples, where the plurality of samples include a plurality of positive samples and a plurality of negative samples;
a building unit, configured to build a plurality batches of training sets, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs;
a training unit, configured to input each batch of training set into a model for training, and obtain a category of each sample in each batch of training set; and
the training unit is further configured to obtain an overall loss value according to the label information and the category of each sample in each batch of training set, a sample quantity in each batch of training set and an overall loss function, and adjust the model according to the overall loss value to obtain a trained model.

In a possible implementation, the training unit is further configured to:
determine the overall loss function, where the overall loss function includes a first loss function and a second loss function;
obtain a first loss value according to the label information and the category of each sample in each batch of training set and the first loss function;
determine a second loss value according to the quantity of the positive samples, a quantity of positive samples with the negative samples, the quantity of the negative samples in each batch of training set and the second loss function; and
obtain the overall loss value according to the first loss value, a weight of the first loss value, the second loss value and a weight of the second loss value.

In a possible implementation, the first loss function is determined based on the following formula:

$${L}^{CE} = - \frac{1}{N} {\sum }_{i = 1}^{N} {\sum }_{k = 1}^{K + 1} {y}_{i , k} \cdot log {\hat{y}}_{i , k}$$

where y indicates the label information, N indicates the sample quantity in each batch of training set, K indicates a category quantity, ŷ indicates the category, and i indicates an index of the positive samples.

In a possible implementation, the second loss function is determined based on the following formula:

$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 )$$

where M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max (pᵢ^{m}−pⱼⁿ+δ, 0) is used to measure a distance between the predicted probability of the category of the positive sample and the predicted probability of the category of a corresponding negative sample.

In a possible implementation, the training unit is specifically configured to:
if the overall loss value is within a preset range, determine that the adjusted model has converged, and take the adjusted model as the trained model.

In a possible implementation, the training unit is further configured to:
when the overall loss value is not within the preset range, generate a new positive sample by using a principle of maximizing a loss value obtained based on a loss function;
calculate a cluster center of each negative sample, and generate a new negative sample based on the cluster center;
obtain a new batch of training set based on the new positive sample and the new negative sample, and input the new batch of training set into the adjusted model for training to obtain a new category of each sample in the new batch of training set; and
obtain a new overall loss value according to label information and the new category of each sample in the new batch of training set and the overall loss function, and determine whether the new overall loss value is within the preset range.

In a possible implementation, the obtaining unit is specifically configured to:
identify the positive samples in the corpus;

perform an word extraction processing on each positive sample to obtain a candidate word corresponding to each positive sample; and respectively build a corresponding regular expression based on the candidate word corresponding to each positive sample; and
build the negative sample corresponding to the positive sample based on each regular expression.

In a third aspect of an embodiment of the present application, there is provided an electronic device, including:
at least one processor; and a memory communicatively connected with the at least one processor; where the memory stores instructions executable by the at least one processor, and the instructions are executed by the at least one processor to realize any of the methods as provided in the first aspect of the present application.

In a fourth aspect of an embodiment of the present application, there is provided a computer-readable storage medium that, when instructions in the computer-readable storage medium are executed by a processor of an electronic device, the electronic device is enabled to perform any of the methods as provided in the first aspect of the present application.

In a fifth aspect of an embodiment of the present application, there is provided a computer program product, including a computer program, which, when executed by a processor, implements any of the methods as provided in the first aspect of the present application.

The technical scheme provided by the embodiments of the present application at least brings the following beneficial effects:
in the embodiments of the present application, a text in a corpus can be processed to obtain a plurality of positive samples and a plurality of negative samples. Then, a plurality batches of training sets are built, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs. It can be seen that the batch of training set in the embodiment of this application includes the positive samples and the negative samples with the preset ratio, so that a variety of classification categories can be added, and the positive samples can be better distinguished by the negative samples, thus improving the accuracy of intention identification for the text.

Further, each batch of training set is input into a model for training, and a category indicating each sample in each batch of training set is obtained. Then, an overall loss value is obtained according to the label information and the category of each sample in each batch of training set, a sample quantity in each batch of training set and an overall loss function, and the model is adjusted according to the overall loss value to obtain a trained model.

It can be seen that in the embodiment of this application, a method for obtaining the negative samples is proposed, and a batch of training set is built based on the negative samples and the positive samples, and based on the batch of training set and a preset overall loss function used to calculate a first loss value and a second loss value, the model is prompted to learn a difference between texts, so that the trained model can accurately identify the intention of the input text and improve the accuracy of the intention identification for the text.

Other features and advantages of the present application will be set forth in the description which follows, and in part will be obvious from the description, or may be learned by practice of the present application. The objects and other advantages of the present application may be realized and obtained by the structure particularly pointed out in the written description and claims, as well as the accompanying drawings.

### BRIEF DESCRIPTION OF DRAWINGS

The accompanying drawings described herein are provided to provide a further understanding of the present application and constitute a part of the present application. The illustrative embodiments of the present application and their descriptions are used to explain the present application and do not constitute undue limitations on the present application. In the attached drawings:

FIG. 1 is a schematic diagram of an application scenario according to an exemplary embodiment.

FIG. 2 is a flowchart of an intention identification method according to an exemplary embodiment.

FIG. 3 is a flowchart of a model training method according to an exemplary embodiment.

FIG. 4 is a schematic diagram of a positive sample and a negative sample corresponding to the positive sample according to an exemplary embodiment.

FIG. 5 is a schematic diagram of adjusting a model according to an exemplary embodiment.

FIG. 6 is a schematic diagram of intention identification for a text based on a trained model according to an exemplary embodiment.

FIG. 7 is a structural block diagram of a model training apparatus according to an exemplary embodiment.

FIG. 8 is a structural block diagram of an intention identification apparatus according to an exemplary embodiment.

FIG. 9 is a structural schematic diagram of an electronic device according to an exemplary embodiment.

### DESCRIPTION OF EMBODIMENTS

In order to make those skilled in the art better understand the technical scheme of the present application, the technical scheme in the embodiments of the present application will be described clearly and completely with the accompanying drawings.

It should be noted that the terms “first” and “second” in the description, the claims and the above accompanying drawings of the present application are used to distinguish similar objects, and are not necessarily used to describe a specific order or a sequence. It should be understood that the objects so used are interchangeable under appropriate circumstances, so that the embodiments of the present application described herein can be implemented in other orders than those illustrated or described herein. The implementations described in the following exemplary embodiments do not represent all implementations consistent with this application. Rather, they are merely examples of apparatuses and methods consistent with some aspects of the present application as detailed in the appended claims.

The following is a brief introduction to the design idea of the embodiment of this application.

At present, as mentioned above, the intention identification model in related technology can only identify the intention category of texts with completely different text expressions, which leads to poor accuracy of intention identification for the texts.

For example, in an intention identification scene for complaint, a general intention identification method can classify a text “I will complain about you” well from other categories for classification, and the identified intention is “complaint”. For the text with similar structure and expression corresponding to the above sentence, such as a text “I'm not scared, go ahead and file a complaint”, the general intention identification method identifies the intention as “complaint”, while the real intention of the text “I'm not scared, go ahead and file a complaint” is “not to complaint”.

It can be seen that in the intention identification scene for complaint, the expression of some complaint intentions is easily influenced by other intentions. However, the intention identification methods in the related technologies cannot accurately identify the foresaid texts.

In view of this, embodiments of the present application provides a model training method, through which a text in a corpus can be processed to obtain a plurality of positive samples and negative samples. Then, a plurality batches of training sets are built, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs. It can be seen that the batch of training set in the embodiment of this application includes the positive samples and the negative samples with the preset ratio, so that a variety of classification categories can be added, and the positive samples can be better distinguished by the negative samples, thus improving the accuracy of intention identification for the text.

Further, each batch of training set is input into a model for training, and a category indicating each sample in each batch of training set is obtained. Then, an overall loss value is obtained according to the label information and the category of each sample in each batch of training set, a sample quantity in each batch of training set and an overall loss function, and the model is adjusted according to the overall loss value to obtain a trained model.

It can be seen that in the embodiment of this application, a method for obtaining the negative samples is proposed, and a batch of training set is built based on the negative samples and the positive samples, and based on the batch of training set and a preset overall loss function used to calculate a first loss value and a second loss value, the model is prompted to learn a difference between texts, so that the trained model can accurately identify the intention of the input text and improve the accuracy of the intention identification for the text.

After introducing the design idea of the embodiments of the present application, the application scenarios to which the technical scheme of the embodiments of the present application can be applied are briefly introduced below. It should be noted that the application scenarios introduced below are only used to illustrate the embodiments of the present application and are not for limitation. In the specific implementation, the technical scheme provided by the embodiments of the present application can be flexibly applied according to actual needs.

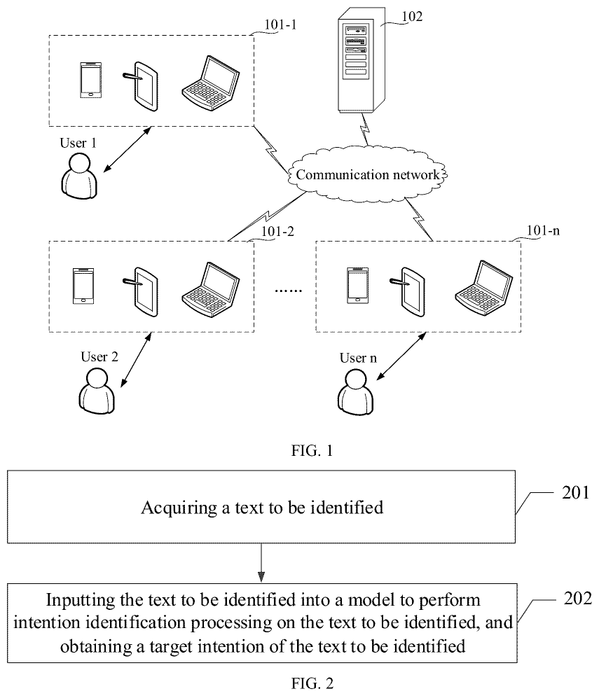

Referring to FIG. 1, FIG. 1 is a schematic diagram of an application scenario of a model training method provided by an embodiment of the present application. The application scenario includes a plurality of terminal devices 101 (including a terminal device 101-1, a terminal device 101-2, . . . a terminal device 101-n) and a server 102. Each terminal device 101 is connected with the server 102 through a wireless or wired network.

The server 102 can be an independent physical server, a server cluster or a distributed system composed of multiple physical servers, and a cloud server that provides basic cloud computing services such as cloud service, cloud database, cloud computing, cloud function, cloud storage, network service, cloud communication, middleware service, domain name service, security service, CDN (Content Delivery Network, Content Delivery Network), big data and artificial intelligence platform. The terminal device 101 may be a smart phone, a tablet computer, a notebook computer, a desktop computer, a smart TV, a smart wearable device, etc., which is not limited herein.

In the scenario shown in FIG. 1, the server 102 processes a text in a corpus to obtain a plurality of samples, where the plurality of samples include a plurality of positive samples and a plurality of negative samples; builds a plurality batches of training sets, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs; inputs each batch of training set into a model for training, and obtains a category of each sample in each batch of training set; and obtains an overall loss value according to the label information and the category of each sample in each batch of training set, a sample quantity in each batch of training set and an overall loss function, and adjusts the model according to the overall loss value to obtain a trained model.

Further, the trained model can be stored in the server 102, so that when the user 1 sends a text to be identified to the server 102 through the terminal device 101-1. The server 102 can, after receiving the text to be identified, input the text to be identified into the trained model, and the trained model performs an intention identification processing on the text to be identified to obtain a target intention of the text to be identified. Further, the server 102 sends the target intention to the terminal device 101-1, and the terminal device 101-1 outputs the target intention to inform the user 1, so that the user 1 can perform a subsequent processing based on the target intention.

In the embodiments of the present application, the model trained by the model-based training method can be applied to various scenarios of customer service business, such as customer service business scenario for urging the customers to repay financial loan, customer service business scenarios for take-away after-sales, customer service scenarios for commodity pre-sales or after-sales, etc, which is not limited by the embodiments of the present application.

For example, it is assumed that the model trained based on the aforementioned model training method is applied to the customer service business scenario for urging the customers to repay financial loan, a customer service for urging the customers to repay financial loan can make a call to a lender based on a communication device to urge the customers to repay financial loan, and then the communication device can perform a voice identification on the conversation content, convert it into a text to be identified, and send the text to be identified to the server, so that a trained model stored in the server can perform an identification on the text to be identified, obtain the target intention, and send the target intention to the communication device, so that the customer service for urging the customers to repay financial loan can carry out subsequent business communication processing based on the target intention, and reduce complaint rate.

Certainly, the method provided by the embodiments of the present application is not limited to the application scenario shown in FIG. 1, but also can be used in other possible application scenarios, which is not limited by the embodiments of the present application. The functions that can be realized by each device in the application scenario shown in FIG. 1 will be described together in the subsequent method embodiments, which is not repeated here.

In order to further explain the scheme of the intention identification method provided by the embodiments of the present application, the following provides detailed explanation with the accompanying drawings and specific implementations. Although the embodiments of the present application provide the method operation steps shown in the following embodiments or accompanying drawings, more or less operation steps can be included in the method based on routine or non-creative labor. In the steps where there is no necessary causal relationship logically, the execution order of these steps is not limited to the execution order provided by the embodiments of the present application. The method can be executed sequentially or in parallel according to the method shown in the embodiments or the accompanying drawings (for example, in an application environment of parallel processors or multithreading) during actual processing or device execution.

The intention identification method in the embodiments of the present application will be described below with reference to the method flow chart shown in FIG. 2, and each step shown in FIG. 2 can be executed by an electronic device shown in FIG. 1.

Step 201: acquiring a text to be identified.

In the embodiments of the present application, the electronic device can receive a text directly input by the user as the text to be identified, and can also receive voice information input by the user, and convert the voice information into a text to obtain the text to be identified. Certainly, it can also automatically obtain the text in the database in batches as the text to be identified, and performs the intention identification on the text to be identified one by one, which is not limited by the embodiments of the present application.

Step 202: inputting the text to be identified into a model to perform intention identification processing on the text to be identified, and obtaining a target intention of the text to be identified.

In the embodiments of the present application, intention identification processing can be processed on the text to be identified through the trained model.

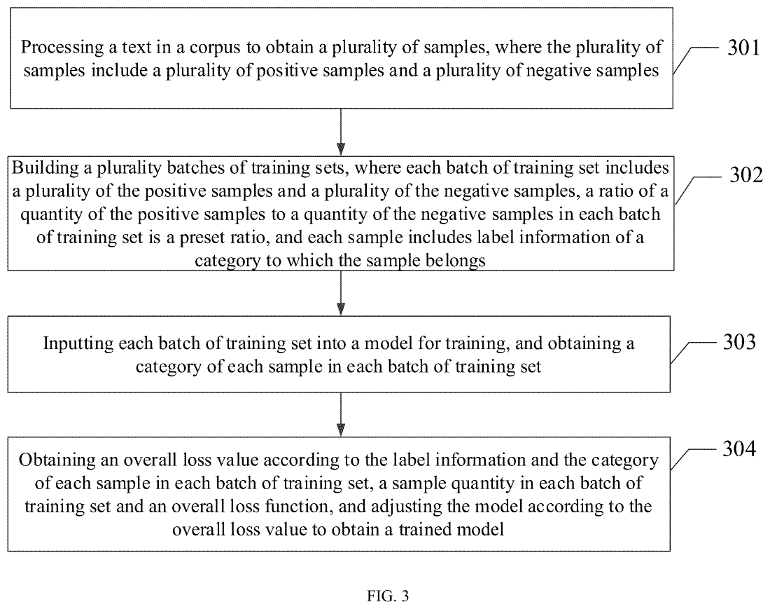

In the embodiments of the present application, in order to better introduce the training process of the model, an exemplary embodiment is introduced below. Please refer to FIG. 3, FIG. 3 is a schematic diagram of a model training process provided by an embodiment of the present application.

Step 301: processing a text in a corpus to obtain a plurality of samples, where the plurality of samples include a plurality of positive samples and a plurality of negative samples.

In the embodiments of the present application, the electronic device may first determine a corpus, which corresponds to the business scenario. For example, it is assumed that the business scenario is an intention identification scenario for complaint, the corpus of a dialogue text between a customer service staff and a customer can be determined as the corpus to be processed.

In the embodiments of the present application, after the electronic device determines the corpus, the text in the corpus can be processed, so as to obtain a plurality of positive samples and a plurality of negative samples. Specifically, in the practical application process, a negative category can be added to the preset intention category as a category to obtain a new intention category. For example, the default intention categories are k categories, then the new intention categories are K+1 categories, where k is a positive integer.

In an implementation, the electronic device can identify positive samples in the corpus; perform an word extraction processing on each positive sample to obtain a candidate word corresponding to each positive sample; and respectively build a corresponding regular expression based on the candidate word corresponding to each positive sample; build the negative sample corresponding to the positive sample respectively based on each regular expression. The building the corresponding regular expression based on the candidate word corresponding to the positive sample can be performed by transforming an arrangement order and an organization manner of the candidate word.

For example, as shown in Table 1, Table 1 is a schematic table of the positive samples and the negative samples corresponding to the positive samples in the embodiments of the present application.

| | | Sample | |
|---|---|---|---|
| Number | Regular expression | category | Examples |
| 1 | I.* call the police | Positive | I'll call the police to arrest |
| | | sample | you if you call again. |
| 2 | I.* call the police | Negative | I wonld not pay it back, go |
| | | sample | ahead and call the police. |
| 3 | I.* call 110 | Positive | I'll call 110 to arrest you. |
| | | sample | |
| 4 | I.* call 110 | Negative | Don't call me. If you want to |
| | | sample | call 110, go ahead. |
| 5 | no.* contact | Positive | I have no contact with him. |
| | | sample | |
| 6 | not.* get in touch | Negative | I didn't get in touch with him. |
| | | sample | |

In the embodiments of the present application, by building negative samples, the above positive samples can be better distinguished, thus improving ability of the model to distinguish such samples with high difficulty in differentiating.

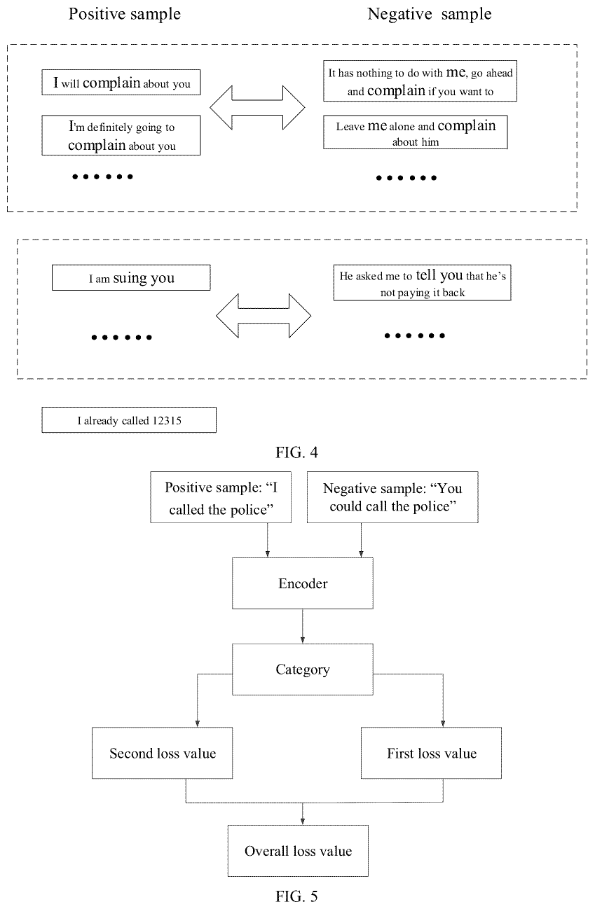

In the embodiments of the present application, the positive sample corresponds to the negative sample, but not all the positive samples of the preset intention category have corresponding negative samples. For example, referring to FIG. 4, FIG. 4 is a schematic diagram of a positive sample and a negative sample corresponding to the positive sample in an embodiment of the present application. FIG. 4 is a sample example in the intention of “mentioning a complaint”. Inside the dotted line, it is indicated that there is a positive sample with a negative sample, and outside the dotted line, it is indicated that there is a positive sample without a negative sample. In an implementation, the positive sample without a negative sample in the initial batch of training set can be discarded, that is, the batch of training set can be built by using the positive samples having negative samples and the corresponding negative samples.

Step 302: building a plurality batches of training sets, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs.

In the embodiments of the present application, each batch of training set (Batch) can initially include positive samples of k categories, and then the negative samples are added to the Batch according to a certain ratio & to form training data of K+1 categories. For example, in a Batch, the positive samples and the negative samples are trained according to ϵ=3:1 by default. In an implementation, negative samples that is one third of the positive samples in quantity can be selected to randomly replace positive samples without corresponding negative samples in all of the positive samples included in the initial Batch, so as to obtain the Batch for training the model.

Step 303: inputting each batch of training set into a model for training, and obtaining a category of each sample in each batch of training set.

Step 304: obtaining an overall loss value according to the label information and the category of each sample in each batch of training set, a sample quantity in each batch of training set and an overall loss function, and adjusting the model according to the overall loss value to obtain a trained model.

In the embodiments of this application, a design concept of “pre-training +fine-tuning” is adopted for model training. Among them, “pre-training” can be understood as that the model is a pre-trained model, such as a pre-trained deep bidirectional Transformer language (Bidirectional Encoder Representations from Transformers, BERT) model or a Long Short-Term Memory network (Long Short-Term Memory, LSTM) model. “Fine-tuning” can be understood as performing adjustment on the model. For example, referring to FIG. 5, FIG. 5 is a schematic diagram for adjusting a model provided by an embodiment of the present application.

In the embodiments of the present application, the sample xᵢ in each batch of training set can be input to the encoder in the preset BERT model, and a corresponding hidden state, namely data information hᵢ, can be obtained, and the formula is as follows:

$${h}_{i} = BERT ( {x}_{i} ) \qquad ( Formula 1 )$$

In the embodiments of the present application, when the sample quality is low and does not conform to conventional language habits, the sample xᵢ in each batch of training set can be input to the encoder in the preset LSTM model, and the corresponding hidden state, namely data information hᵢ, is obtained, and the formula is as follows:

$${h}_{i} = LSTM ( {x}_{i} ) \qquad ( Formula 2 )$$

In the embodiments of the present application, after the hidden state of the sample Xᵢ is obtained, it is input into a fully connected layer in the model for classification, and an intention identification result is obtained by:

$${\hat{y}}_{i} = softmax ( {W}_{c} {h}_{i} + {b}_{c} ) \qquad ( Formula 3 )$$

where ŷ is the category, W_{c} and b_{c} are parameters to be trained, W_{c} is used to represent a weight, b_{c} is used to represent an offset, and softmax is used to represent an activation function.

In the embodiments of the present application, after the electronic device obtains the category corresponding to each sample in each batch of training set, the electronic device can obtain the overall loss value according to the label information and the identified category corresponding to each sample, the sample quantity in each batch of training set and the overall loss function, and adjust the model according to the overall loss value to obtain the trained model.

In the embodiments of the present application, the electronic device can determine the overall loss function, where the overall loss function includes a first loss function and a second loss function; then, obtain a first loss value according to the label information and the category of each sample in each batch of training set and the first loss function; determine a second loss value according to the quantity of the positive samples, a quantity of positive samples with the negative samples, the quantity of the negative samples in each batch of training set and the second loss function; and obtain the overall loss value according to the first loss value, a weight of the first loss value, the second loss value and a weight of the second loss value.

In an implementation, the first loss function is determined based on the following Formula 4:

$${L}^{CE} = - \frac{1}{N} {\sum }_{i = 1}^{N} {\sum }_{k = 1}^{K + 1} {y}_{i , k} \cdot log {\hat{y}}_{i , k} \qquad ( Formula 4 )$$

where y indicates the label information, N indicates the sample quantity in each batch of training set, K indicates a category quantity, ŷ indicates the category, and i indicates an index of the positive samples. For example, y is a positive integer such as 0 or 1, and ŷ is a numerical value between 0 and 1.

In an implementation, the second loss function is determined based on the following Formula 5:

$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 ) \qquad ( Formula 5 )$$

where M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max(pᵢ^{m}−pⱼⁿ+δ, 0) is used to measure a distance between the predicted probability of the category of the positive sample and the predicted probability of the category of a corresponding negative sample.

Thus, the overall loss value can be determined based on the following Formula 6:

$$L = ϑ {L}^{CE} + γ {L}^{con} \qquad ( Formula 6 )$$

where ϑ represents the weight of the first loss value, γ represents the weight of the second loss value, L^{CE} represents the first loss value, L^{con} represents the second loss value, and L represents the overall loss value. In an implementation, ϑ can be 1.

In the embodiments of the present application, after the electronic device obtains the overall loss value, it can determine whether the overall loss value is within a preset range; if the overall loss value is in the preset range, it is determined that the adjusted model has converged, and the adjusted model is taken as the trained model.

In an implementation, when the overall loss value is not in the preset range, a new positive sample can be generated by using a principle of maximizing a loss value obtained based on a loss function; a cluster center of each negative sample is calculated, and a new negative sample is generated based on the cluster center; a new batch of training set is obtained based on the new positive sample and the new negative sample, the new batch of training set is input into the adjusted model for training to obtain a new category of each sample in the new batch of training set; and a new overall loss value is obtained according to label information and a new category of each sample in the new batch of training set and the overall loss function, and whether the new overall loss value is within the preset range is determined.

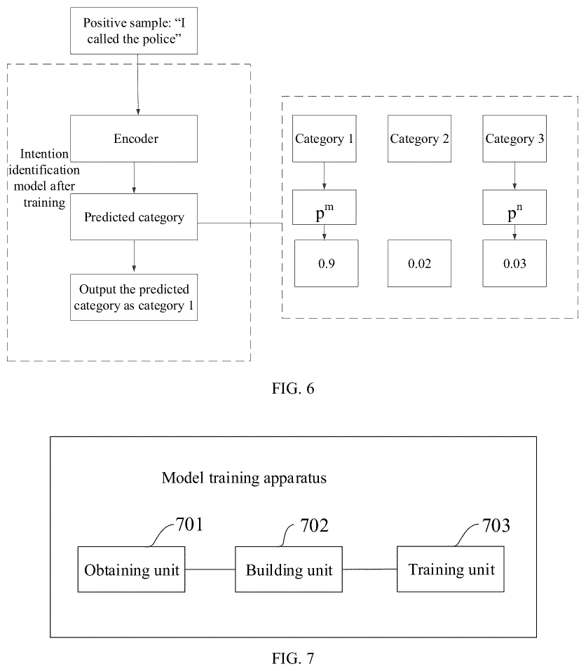

In other words, in the embodiments of the present application, the model is continuously fine-tuned by continuously judging the overall loss value corresponding to the currently adjusted model, so as to finally obtain the trained model, and the intention of the text is identified based on the trained model. For example, referring to FIG. 6, FIG. 6 is a schematic diagram of a process of text identification by a model in an embodiment of the present application.

In an implementation, when the intention identification is performed on the text based on the trained model, if the identified result is the intention corresponding to the negative category, this category is not fed back, and prompt information is output to prompt that the text does not belong to the identification type required by the business scenario corresponding to the model. In other words, only the identified categories of K-type original intention corresponding to the positive sample is fed back. It can be seen that the model provided by the embodiments of the present application can improve the identification ability for texts while maintaining the classification effect for the original intention.

Based on the same inventive concept, the embodiments of the present application provides a model training apparatus, which can realize the functions corresponding to the aforementioned model training method. The model training apparatus can be hardware structure, software module, or hardware structure plus software module. The training device of this model can be realized by a chip system, which can be composed of chips or include chips and other discrete devices. As shown in FIG. 7, the apparatus includes an obtaining unit 701, a building unit 702, and a training unit 703.

The obtaining unit 701 is configured to process a text in a corpus to obtain a plurality of samples, where the plurality of samples include a plurality of positive samples and a plurality of negative samples.

The building unit 702 is configured to build a plurality batches of training sets, where each batch of training set includes a plurality of the positive samples and a plurality of the negative samples, a ratio of a quantity of the positive samples to a quantity of the negative samples in each batch of training set is a preset ratio, and each sample includes label information of a category to which the sample belongs.

The training unit 703 is configured to input each batch of training set into a model for training, and obtain a category of each sample in each batch of training set.

The training unit 703 is further configured to obtain an overall loss value according to the label information and the category of each sample in each batch of training set, a sample quantity in each batch of training set and an overall loss function, and adjust the model according to the overall loss value to obtain a trained model.

In one possible embodiment, the training unit 703 is specifically configured to:
determine the overall loss function, where the overall loss function includes a first loss function and a second loss function;
obtain a first loss value according to the label information and the category of each sample in each batch of training set and the first loss function;
determine a second loss value according to the quantity of the positive samples, a quantity of positive samples with the negative samples, the quantity of the negative samples in each batch of training set and the second loss function; and
obtain the overall loss value according to the first loss value, a weight of the first loss value, the second loss value and a weight of the second loss value.

In one possible embodiment, the first loss function is determined based on the following formula:

$${L}^{CE} = - \frac{1}{N} {\sum }_{i = 1}^{N} {\sum }_{k = 1}^{K + 1} {y}_{i , k} \cdot log {\hat{y}}_{i , k}$$

where y indicates the label information, N indicates the sample quantity in each batch of training set, K indicates a category quantity, ŷ indicates the category, and i indicates an index of the positive samples.

In one possible embodiment, the second loss function is determined based on the following formula:

$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 )$$

where M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max (pᵢ^{m}−pⱼⁿ+δ, 0) is used to measure a distance between the predicted probability of the category of the positive sample and the predicted probability of the category of a corresponding negative sample.

In one possible embodiment, the training unit 703 is specifically configured to:
if the overall loss value is within a preset range, determine that the adjusted model has converged, and take the adjusted model as the trained model.

In a possible embodiment, the training unit 703 is further configured to:
when the overall loss value is not within the preset range, generate a new positive sample by using a principle of maximizing a loss value obtained based on a loss function;
calculate a cluster center of each negative sample, and generate a new negative sample based on the cluster center;
obtain a new batch of training set based on the new positive sample and the new negative sample, and input the new batch of training set into the adjusted model for training to obtain a new category of each sample in the new batch of training set; and
obtain a new overall loss value according to label information and the new category of each sample in the new batch of training set and the overall loss function, and determine whether the new overall loss value is within the preset range.

In a possible embodiment, the obtaining unit 701 is specifically configured to:
identify the positive samples in the corpus;
perform an word extraction processing on each positive sample to obtain a candidate word corresponding to each positive sample; and respectively build a corresponding regular expression based on the candidate word corresponding to each positive sample; and
build the negative sample corresponding to the positive sample based on each regular expression.

All the related contents of the steps involved in the embodiments of the model training method as shown in FIG. 3 can be introduced to the functional description of the functional unit corresponding to the model training apparatus in the embodiment of this application, which will not be repeated here.

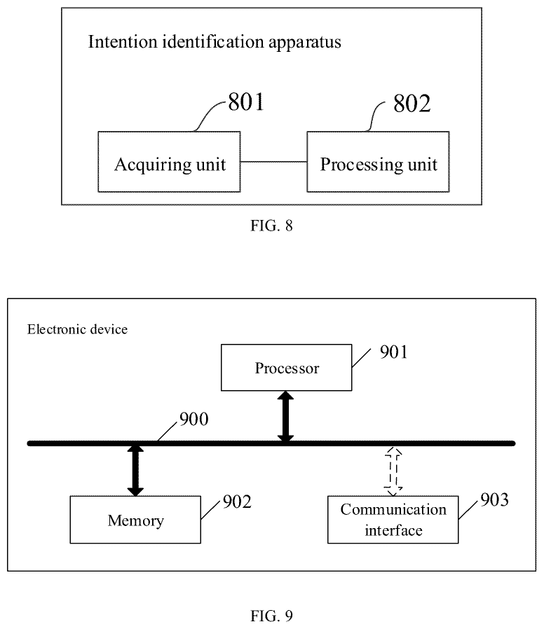

Based on the same inventive concept, embodiments of the present application provides an intention identification apparatus, which can realize the functions corresponding to the aforementioned intention identification method. The intention identification device can be a hardware structure, a software module, or a hardware structure plus a software module. The intention identification apparatus can be realized by a chip system, which can be composed of chips, and can also include chips and other discrete devices. As shown in FIG. 8, the apparatus includes an acquiring unit 801 and a processing unit 802. Among them:
the acquiring unit 801 is configured to acquire a text to be identified; and
the processing unit 802 is configured to input the text to be identified into a model to perform intention identification processing on the text to be identified, and obtain a target intention of the text to be identified;
where the model is trained according to the aforesaid model training method.

All the related contents of the steps involved in the embodiments of the intention identification method as shown in FIG. 2 can be introduced to the functional description of the functional unit corresponding to the intention identification apparatus in the embodiment of this application, which will not be repeated here.

The division of units in the embodiments of this application is schematic, which is only a logical function division, and there may be other division methods in actual implementation. In addition, each functional unit in each embodiment of this application may be integrated in a processor, or may exist physically alone, or two or more units may be integrated in one unit. The above mentioned integrated units can be realized in the form of hardware or in a form of software functional units.

Based on the same inventive concept, embodiments of the present application also provides an electronic device, such as the server 102 in FIG. 1. As shown in FIG. 9, the electronic device in the embodiments of the present application includes at least one processor 901, a memory 902 connected with the at least one processor 901 and a communication interface 903. The specific connection medium between the processor 901 and the memory 902 is not limited in the embodiments of the present application. In FIG. 9, the connection between the processor 901 and the memory 902 being a bus 900 is taken as an example, and the bus 900 is represented by a thick line in FIG. 9, and the connection manners between other components is only a schematic illustration with no limitation. The bus 900 can be divided into address bus, control bus, etc. For convenience of representation, only one thick line is illustrated in FIG. 9, but it does not mean that there is only one bus or one type of bus.

In embodiments of the present application, the memory 902 stores instructions that can be executed by at least one processor 901, and the at least one processor 901 can execute the steps included in the model training method by executing instructions stored in the memory 902.

Among them, the processor 901 is the control center of the server, which can connect all parts of the whole model training apparatus with various interfaces and lines, calculate various functions of the device and process the text by running or executing the instructions stored in the memory 902 and calling the data stored in the memory 902, thus realizing the intention identification for the text. In an implementation, the processor 901 may include one or more processing units, and the processor 901 may integrate an application processor and a modem processor, where the processor 901 mainly handles the operating system, user interface, application programs and the like, and the modem processor mainly handles wireless communication. It can be understood that the above modem processor may not be integrated into the processor 901. In some embodiments, the processor 901 and the memory 902 can be implemented on the same chip, and in some embodiments, they can also be implemented separately on independent chips.

The processor 901 may be a general-purpose processor, such as a central processing unit, i.e., a CPU, a digital signal processor, an application specific integrated circuit, a field programmable gate array or other programmable logic device, a discrete gate or transistor logic device, and a discrete hardware component, and may realize or execute the methods, steps and logic block diagrams disclosed in the embodiments of the present application. The general processor can be a microprocessor or any conventional processor, etc. The steps of the method disclosed in the embodiments of the present application can be directly embodied as being executed and completed by a hardware processor, or being executed and completed by a combination of hardware and software modules in the processor.

As a nonvolatile computer-readable storage medium, the memory 902 can be used to store nonvolatile software programs, nonvolatile computer-executable programs and modules. The memory 902 may include at least one type of storage medium, such as flash memory, hard disk, multimedia card, card memory, Random Access Memory (Random Access Memory, RAM), Static Random Access Memory (Static Random Access Memory, SRAM), SRAM), Programmable Read Only Memory (Programmable Read Only Memory, PROM), Read Only Memory (Read Only Memory, ROM), electrically erasable programmable read-only memory (Electrically Erasable Programmable Read-Only memory EEPROM), magnetic memory, magnetic disk, optical disk, etc. The memory 902 is any other medium that can be used to carry or store desired program codes in the form of instructions or image structures and can be accessed by a computer, which is not limited herein. The memory 902 in the embodiments of the present application can also be a circuit or any other apparatus that can realize the storage function, and is used for storing program instructions and/or images.

The communication interface 903 is a transmission interface that can be used for communication, and data can be received or sent through the communication interface 903.

In an exemplary embodiment, there is also provided a computer-readable storage medium including instructions, such as a memory including instructions, which can be executed by a processor of a device to complete the aforesaid intention identification method or model training method. In an implementation, the computer-readable storage medium can be ROM, random access memory (RAM), compact disc read only memory (CD-ROM), magnetic tape, floppy disk, optical image storage device, etc.

In an exemplary embodiment, a computer program product is also provided, which includes program code, and when the program product is running on a server, the program code is used for causing the server to perform the steps in the intention identification method or model training method according to various exemplary embodiments of the present application described above in this specification.

It should be understood by those skilled in the art that embodiments of the present application can be provided as a method, a system, or a computer program product. Therefore, this application can take the form of an entirely hardware embodiment, an entirely software embodiment, or an embodiment combining software and hardware aspects. Moreover, the present application can adopt one or more computer-usable storage media including computer-usable program codes therein, and the computer-usable storage media include, but are not limited to, disk storage, optical storage and other forms of computer program products implemented above.

The present application is described with reference to flowcharts and/or block diagrams of methods, servers, computer-readable storage media and computer program products according to embodiments of the present application. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, a special-purpose computer, an embedded processor or other programmable electronic device to produce a machine, such that the instructions executed by the processor of the computer or other programmable electronic device produce means for implementing the functions specified in one or more flows in the flowchart and/or one or more blocks in the block diagram.

These computer program instructions may also be stored in a computer-readable memory that can direct a computer or other programmable electronic device to function in a specific manner, such that the instructions stored in the computer-readable memory produce an article of manufacture including instruction means that implement the functions specified in one or more flows in the flowchart and/or one or more blocks in the block diagram.

These computer program instructions may also be loaded onto a computer or other programmable electronic device, such that a series of operational steps are performed on the computer or other programmable device to produce computer-implemented processes, so that the instructions executed on the computer or other programmable device provide steps for implementing the functions specified in one or more flows in the flowchart and/or one or more blocks in the block diagram.

Obviously, various modifications and variations can be made to this application by those skilled in the art without departing from the spirit and scope of this application. Thus, if these modifications and variations of this application are within the scope of the claims and their equivalents of this application, this application is also intended to include these modifications and variations.

What is claimed is:

1. A model training method, comprising:
processing a text in a corpus to obtain a plurality of samples, wherein the plurality of samples comprise a plurality of positive samples and a plurality of negative samples;
building a plurality batches of training sets, wherein each batch of training set comprises a plurality of the positive samples and a plurality of the negative samples, a ratio of a quantity of the positive samples to a quantity of the negative samples in each batch of training set is a preset ratio, and each sample comprises label information of a category to which the sample belongs;
inputting each batch of training set into a model for training, and obtaining a category of each sample in each batch of training set; and
obtaining an overall loss value according to the label information and the category of each sample in each batch of training set, a sample quantity in each batch of training set and an overall loss function, and adjusting the model according to the overall loss value to obtain a trained model.

2. The method according to claim 1, wherein the obtaining the overall loss value according to the label information and the category of each sample in each batch of training set, the sample quantity in each batch of training set and the overall loss function comprises:
determining the overall loss function, wherein the overall loss function comprises a first loss function and a second loss function;
obtaining a first loss value according to the label information and the category of each sample in each batch of training set and the first loss function;
determining a second loss value according to the quantity of the positive samples, a quantity of positive samples with the negative samples, the quantity of the negative samples in each batch of training set and the second loss function; and
obtaining the overall loss value according to the first loss value, a weight of the first loss value, the second loss value and a weight of the second loss value.

3. The method according to claim 2, wherein the first loss function is determined based on the following formula:
$${L}^{CE} = - \frac{1}{N} {\sum }_{i = 1}^{N} {\sum }_{k = 1}^{K + 1} {y}_{i , k} \cdot log {\hat{y}}_{i , k}$$
wherein y indicates the label information, N indicates the sample quantity in each batch of training set, K indicates a category quantity, ŷ indicates the category, and i indicates an index of the positive samples.

4. The method according to claim 2, wherein the second loss function is determined based on the following formula:
$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 )$$
wherein M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max (pₙ^{m}−pⱼⁿ+δ, 0) is used to measure a distance between the predicted probability of the category of the positive sample and the predicted probability of the category of a corresponding negative sample.

5. The method according to claim 1, wherein the adjusting the model according to the overall loss value to obtain the trained model comprises:
if the overall loss value is within a preset range, determining that the adjusted model has converged, and taking the adjusted model as the trained model.

6. The method according to claim 5, further comprising:
when the overall loss value is not within the preset range, generating a new positive sample by using a principle of maximizing a loss value obtained based on a loss function;
calculating a cluster center of each negative sample, and generating a new negative sample based on the cluster center;
obtaining a new batch of training set based on the new positive sample and the new negative sample, and inputting the new batch of training set into the adjusted model for training to obtain a new category of each sample in the new batch of training set; and
obtaining a new overall loss value according to label information and the new category of each sample in the new batch of training set and the overall loss function, and determining whether the new overall loss value is within the preset range.

7. The method according to claim 1, wherein the processing the text in the corpus to obtain the plurality of samples comprises:
identifying the positive samples in the corpus;
performing an word extraction processing on each positive sample to obtain a candidate word corresponding to each positive sample; and respectively building a corresponding regular expression based on the candidate word corresponding to each positive sample; and
building the negative sample corresponding to the positive sample based on each regular expression.

8. A model training apparatus, comprising:
a processor and a memory in communication connection with the processor;
wherein the memory stores computer-executable instructions; and
the processor, when executing the computer-executable instructions stored in the memory, is configured to:
process a text in a corpus to obtain a plurality of samples, wherein the plurality of samples comprise a plurality of positive samples and a plurality of negative samples;
build a plurality batches of training sets, wherein each batch of training set comprises a plurality of the positive samples and a plurality of the negative samples, a ratio of a quantity of the positive samples to a quantity of the negative samples in each batch of training set is a preset ratio, and each sample comprises label information of a category to which the sample belongs;
input each batch of training set into a model for training, and obtain a category of each sample in each batch of training set; and
obtain an overall loss value according to the label information and the category of each sample in each batch of training set, a sample quantity in each batch of training set and an overall loss function, and adjust the model according to the overall loss value to obtain a trained model.

9. The apparatus according to claim 8, wherein the processor is configured to:
determine the overall loss function, wherein the overall loss function comprises a first loss function and a second loss function;
obtain a first loss value according to the label information and the category of each sample in each batch of training set and the first loss function;
determine a second loss value according to the quantity of the positive samples, a quantity of positive samples with the negative samples, the quantity of the negative samples in each batch of training set and the second loss function; and
obtain the overall loss value according to the first loss value, a weight of the first loss value, the second loss value and a weight of the second loss value.

10. The apparatus according to claim 9, wherein the first loss function is determined based on the following formula:
$${L}^{CE} = - \frac{1}{N} {\sum }_{i = 1}^{N} {\sum }_{k = 1}^{K + 1} {y}_{i , k} \cdot log {\hat{y}}_{i , k}$$
wherein y indicates the label information, N indicates the sample quantity in each batch of training set, K indicates a category quantity, ŷ indicates the category, and i indicates an index of the positive samples.

11. The apparatus according to claim 9, wherein the second loss function is determined based on the following formula:
$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 )$$
wherein M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max (pᵢ^{m}−pⱼⁿ−+δ, 0) is used to measure a distance between the predicted probability of the category of the positive sample and the predicted probability of the category of a corresponding negative sample.

12. The apparatus according to claim 8, wherein the processor is configured to:
if the overall loss value is within a preset range, determine that the adjusted model has converged, and take the adjusted model as the trained model.

13. The apparatus according to claim 12, wherein the processor is configured to:
when the overall loss value is not within the preset range, generate a new positive sample by using a principle of maximizing a loss value obtained based on a loss function;
calculate a cluster center of each negative sample, and generate a new negative sample based on the cluster center;
obtain a new batch of training set based on the new positive sample and the new negative sample, and input the new batch of training set into the adjusted model for training to obtain a new category of each sample in the new batch of training set; and
obtain a new overall loss value according to label information and the new category of each sample in the new batch of training set and the overall loss function, and determine whether the new overall loss value is within the preset range.

14. The apparatus according to claim 8, wherein the processor is configured to:
identify the positive samples in the corpus;
perform an word extraction processing on each positive sample to obtain a candidate word corresponding to each positive sample; and respectively build a corresponding regular expression based on the candidate word corresponding to each positive sample; and
build the negative sample corresponding to the positive sample based on each regular expression.

15. A non-transitory computer storage medium storing a computer program for enabling a computer to execute the following operations:
processing a text in a corpus to obtain a plurality of samples, wherein the plurality of samples comprise a plurality of positive samples and a plurality of negative samples;
building a plurality batches of training sets, wherein each batch of training set comprises a plurality of the positive samples and a plurality of the negative samples, a ratio of a quantity of the positive samples to a quantity of the negative samples in each batch of training set is a preset ratio, and each sample comprises label information of a category to which the sample belongs;
inputting each batch of training set into a model for training, and obtaining a category of each sample in each batch of training set; and
obtaining an overall loss value according to the label information and the category of each sample in each batch of training set, a sample quantity in each batch of training set and an overall loss function, and adjusting the model according to the overall loss value to obtain a trained model.

16. The non-transitory computer storage medium according to claim 15, wherein the computer is configured to execute the following operations:
determining the overall loss function, wherein the overall loss function comprises a first loss function and a second loss function;
obtaining a first loss value according to the label information and the category of each sample in each batch of training set and the first loss function;
determining a second loss value according to the quantity of the positive samples, a quantity of positive samples with the negative samples, the quantity of the negative samples in each batch of training set and the second loss function; and
obtaining the overall loss value according to the first loss value, a weight of the first loss value, the second loss value and a weight of the second loss value.

17. The non-transitory computer storage medium according to claim 16, wherein the first loss function is determined based on the following formula:
$${L}^{CE} = - \frac{1}{N} {\sum }_{i = 1}^{N} {\sum }_{k = 1}^{K + 1} {y}_{i , k} \cdot log {\hat{y}}_{i , k}$$
wherein y indicates the label information, N indicates the sample quantity in each batch of training set, K indicates a category quantity, ŷ indicates the category, and i indicates an index of the positive samples.

18. The non-transitory computer storage medium according to claim 16, wherein the second loss function is determined based on the following formula:
$${L}^{con} = - \frac{1}{M} {\sum }_{i = 1}^{M} {\sum }_{j} {p}_{j}^{n} \cdot max ( {p}_{i}^{m} - {p}_{j}^{n} + δ , 0 )$$
wherein M represents the quantity of the positive samples with the negative samples in each batch of training set, m represents the quantity of the positive samples in each batch of training set, n represents the quantity of the negative samples in each batch of training set, i represents an index of the positive samples, j represents an index of the negative samples, pᵢ^{m} represents a predicted probability of the category of the positive samples, pⱼⁿ represents a predicted probability of the category of the negative samples, δ is a distance threshold, and max (pᵢ^{m}−pⱼⁿ+δ, 0) is used to measure a distance between the predicted probability of the category of the positive sample and the predicted probability of the category of a corresponding negative sample.

19. The non-transitory computer storage medium according to claim 15, wherein the computer is configured to execute the following operations:
if the overall loss value is within a preset range, determining that the adjusted model has converged, and taking the adjusted model as the trained model.

20. The non-transitory computer storage medium according to claim 19, wherein the computer is configured to execute the following operations:
when the overall loss value is not within the preset range, generating a new positive sample by using a principle of maximizing a loss value obtained based on a loss function;
calculating a cluster center of each negative sample, and generating a new negative sample based on the cluster center;
obtaining a new batch of training set based on the new positive sample and the new negative sample, and inputting the new batch of training set into the adjusted model for training to obtain a new category of each sample in the new batch of training set; and
obtaining a new overall loss value according to label information and the new category of each sample in the new batch of training set and the overall loss function, and determining whether the new overall loss value is within the preset range.
